(19) United States
(12) Patent Application Publication
(10) Pub. No.: US 2026/0181151 A1
(43) Pub. Date: Jun. 25, 2026

(54) METHOD AND DEVICE FOR DECODING DATA REPRESENTATIVE OF A SOUND OR VISUAL CONTENT, METHOD AND DEVICE FOR CODING SUCH DATA, AND ASSOCIATED DATA STREAM

(71) Applicant: FONDATION B-COM, CESSON SEVIGNE (FR)

(72) Inventors: Gordon CLARE, Pace (FR); Fatimatou DIENG, Rennes (FR); Félix HENRY, SAINT GREGOIRE (FR)

(21) Appl. No.: 19/425,584

(22) Filed: Dec. 18, 2025

(30) Foreign Application Priority Data
Dec. 24, 2024 (FR) 2415236

(51) Int. Cl. H04N 19/132; H04N 19/117; H04N 19/136; H04N 19/186; H04N 19/42; H04N 19/80

(52) U.S. Cl. CPC H04N 19/132; H04N 19/117; H04N 19/136; H04N 19/186; H04N 19/42; H04N 19/80

(57) ABSTRACT

A method for decoding data representative of an audio or visual content, devices, and associated data streams, include decoding first data so as to obtain a signal at a first resolution, decoding second data so as to obtain a plurality of weights, oversampling the signal at the first resolution into a signal at a second resolution higher than the first resolution, filtering the signal at the second resolution, the filtering including at least one convolution by a convolution matrix, at least some of the coefficients of which are respectively the weights of the plurality of weights.

### TECHNICAL FIELD OF THE INVENTION

The present invention relates to the technical field of audio and video encoding. In particular, it relates to a method and a device for decoding data representative of an audio or visual content, a method and a device for encoding such data, and an associated data stream.

### STATE OF THE ART

It has been proposed in the prior art to use artificial neural networks to improve the quality of reconstruction of oversampled images.

Reference can be made for example to the article “Enhanced Deep Residual Networks for Single Image Super-Resolution” by Bee Lim et al., published on the occasion of the “Computer Vision and Pattern Recognition 2017” conference.

These solutions allow processing any type of images, but have, on the other hand, a relatively high computation cost. Moreover, the artificial neural network is optimised for processing subsampled images using a given subsampling process and is therefore not adapted for processing images subsampled using another subsampling process.

### DISCLOSURE OF THE INVENTION

In this context is proposed a method for decoding data representative of an audio or visual content, comprising the following steps:
decoding first data so as to obtain a signal at a first resolution;
decoding second data so as to obtain a plurality of weights;
oversampling the signal at the first resolution into a signal at a second resolution higher than the first resolution;
filtering the signal at the second resolution, the filtering comprising at least one convolution by means of a convolution matrix, at least some of the coefficients of which are respectively the weights of the plurality of weights.

The filtering, defined adaptively by decoding of the second data, makes it possible to improve the quality of the oversampled signal (e.g., by making it approach an original signal that is desired to be reproduced).

The method can further comprise a step of decoding third data indicating a location of said weights within the convolution matrix.

These third data can comprise fourth data defining the shape of a pattern at which said weights are placed within the convolution matrix. These fourth data thus comprise for example an identifier that identifies said shape among a plurality of predetermined shapes.

Some at least of the third data can moreover define an extent of said pattern within the convolution matrix.

The above-mentioned filtering can comprise a plurality of convolutions implemented respectively (and successively) using a plurality of convolution matrices each defined at least in part by weights obtained by decoding part of the second data.

The third data can then comprise, for each convolution matrix of the plurality of convolution matrices, data indicating a location of the weights within the convolution matrix concerned.

Moreover, the third data can comprise a number of convolutions for which the third data comprise data indicating a location of the weights.

As an alternative, the number of convolutions for which the third data comprise data indicating a location of the weights can be determined.

The convolutions for which the third data comprise data indicating a location of the weights are for example the first convolutions (in the order of application of the convolutions).

The above-mentioned filtering can comprise at least one convolution implemented by means of a predetermined convolution matrix, or several convolutions implemented by means respectively of a plurality of predetermined convolution matrices (some of which can possibly be distinct from each other).

Said at least one convolution can be implemented in practice by a layer of an artificial neural network.

The method can then comprise a step of decoding data (belonging to third data in the example described hereinafter and) indicating a number of layers of the artificial neural network for which weights are encoded among the second data.

In some embodiments, the second resolution can be twice the first resolution in each one of the dimensions of the signal.

When the audio or visual content is an image, the first resolution and the second resolution can be spatial resolutions.

When the image is defined by several components, the decoding of the first data can be followed by step of converting from a first colour representation system to a second colour representation system.

It is also proposed a method for encoding data representative of an audio or visual content, comprising the following steps:
subsampling, into a signal at a first resolution, a signal at a second resolution higher than the first resolution;
encoding the signal at the first resolution so as to obtain first data;
obtaining an intermediate signal by decoding the first data and oversampling to the second resolution;
determining a plurality of weights that minimise a criterion involving a distance between the signal at the second resolution, transformed by colorimetric conversion or not, and a signal produced by filtering the intermediate signal using at least one convolution by means of a convolution matrix, at least some coefficients of which are respectively the weights of the plurality of weights;
encoding the determined weights so as to obtain second data.

This method can comprise, for each of a plurality of configurations of the weights within the convolution matrix, a step of determining a set of weights that minimises a criterion involving a distance between the signal at the second resolution and a signal produced by filtering the intermediate signal using at least one convolution by means of a convolution matrix having the configuration concerned and defined by this set of weights, the encoded weights being the weights of the set of weights for which the produced signal satisfies a predetermined criterion.

The method can comprise a step of encoding third data indicating the location of the weights within the convolution matrix in the configuration for which the produced signal satisfies the predetermined criterion.

When the above-mentioned content is a video sequence, the steps of encoding and determining a plurality of weights (with the associated location) can be performed for each of the images of the video sequence.

For the decoding, the decoding device will then receive first data, second data and third data as defined hereinabove for each of the images of the video sequence. Each image of the video sequence could thus be decoded (by the decoding, oversampling and filtering steps) in accordance with what has been described hereinabove.

It is also proposed a device for decoding data representative of an audio or visual content, comprising:
a decoding unit configured to decode first data to obtain a signal at a first resolution and second data to obtain a plurality of weights;
an oversampling unit configured to oversample the signal at the first resolution into a signal at a second resolution higher than the first resolution;
a filtering unit configured to filter the signal at the second resolution, the filtering unit being configured to apply at least one convolution by means of a convolution matrix, at least some of the coefficients of which are respectively the weights of the plurality of weights.

It is also proposed a device for encoding data representative of an audio or visual content, comprising:
a subsampling unit configured to subsample, into a signal at a first resolution, a signal at a second resolution higher than the first resolution;
an encoding unit configured to encode the signal at the first resolution so as to obtain first data;
a decoding unit configured to obtain a decoded signal at the first resolution by decoding the first data;
an oversampling unit configured to oversample the decoded signal, respectively transformed by colorimetric conversion or not, so as to obtain an intermediate signal at the second resolution;
a learning unit configured to determine a plurality of weights that minimise a criterion involving a distance between the signal at the second resolution, respectively transformed by colorimetric conversion or not, and a signal produced by filtering the intermediate signal using at least one convolution by means of a convolution matrix, at least some coefficients of which are respectively the weights of the plurality of weights;
wherein the encoding unit is configured to encode the determined weights so as to obtain second data.

Finally, it is proposed a data stream representative of an audio or visual content, comprising first data representing a signal at a first resolution and second data representing weights usable as coefficients of a convolution matrix useful for filtering a signal at a second resolution obtained by oversampling of the signal at the first resolution.

Such a data stream can also comprise third data indicating a location of said weights within the convolution matrix.

Obviously, the different features, alternatives and embodiments of the invention can be associated with each other according to various combinations, insofar as they are not incompatible or exclusive with respect to each other.

### DETAILED DESCRIPTION OF THE INVENTION

Moreover, various other features of the invention emerge from the appended description made with reference to the drawings that illustrate non-limiting embodiments of the invention, and wherein:

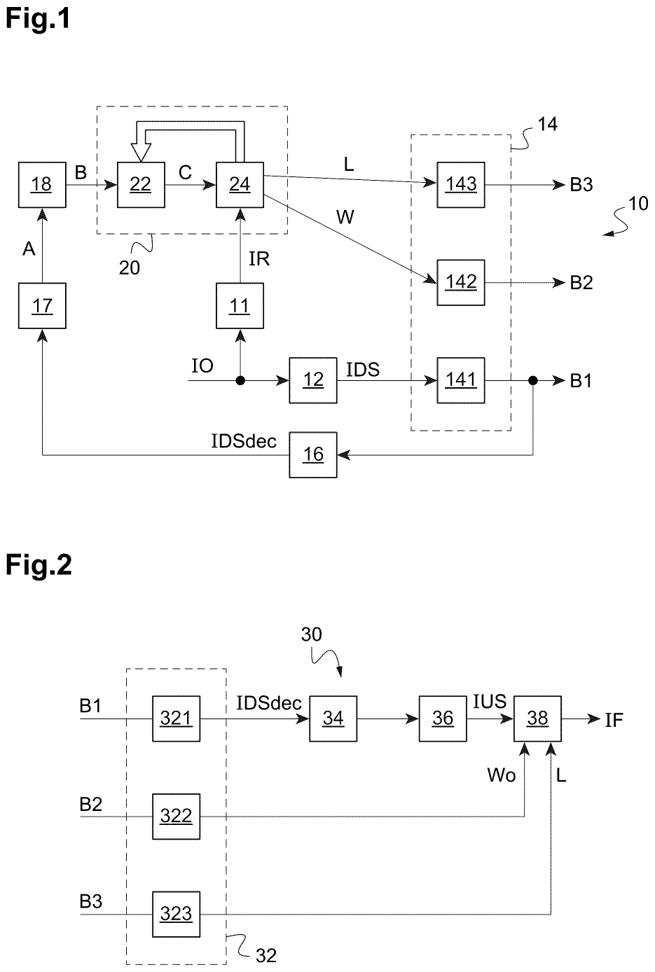

FIG. 1 shows the main elements of a device for encoding data representative of an image;

FIG. 2 shows the main elements of a device for decoding data representative of an image;

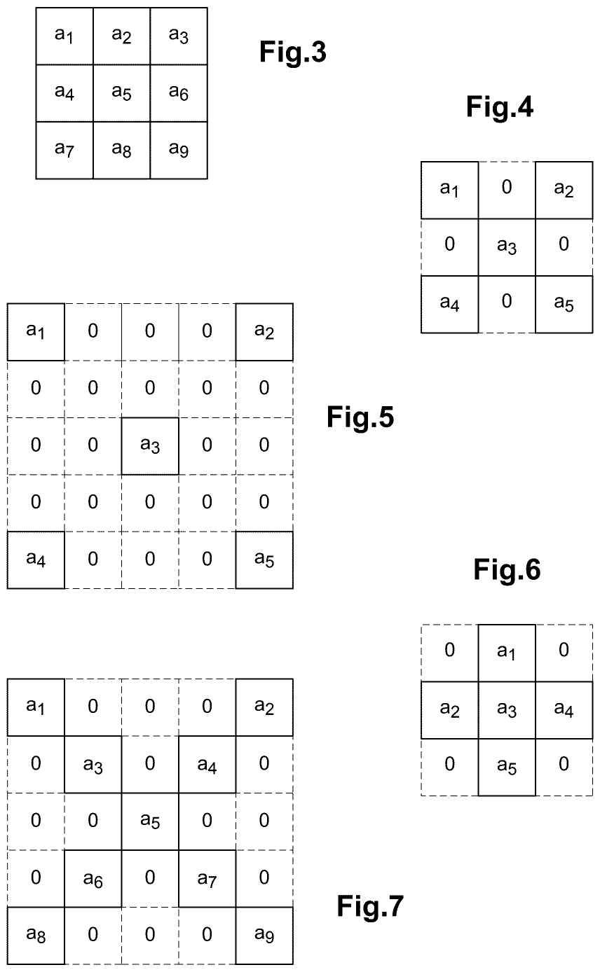

FIG. 3 shows a first example of a convolution matrix usable in these devices;

FIG. 4 shows a second example of a convolution matrix usable in these devices;

FIG. 5 shows a third example of a convolution matrix usable in these devices;

FIG. 6 shows a fourth example of a convolution matrix usable in these devices; and

FIG. 7 shows a fifth example of a convolution matrix usable in these devices.

The present contribution is in the field of encoding and decoding data representative of an audio or video content.

In the following description are presented embodiments in which this content is an image. The solution proposed nevertheless applies without difficulties to other audio or visual contents, e.g. a video sequence (in which case the solution applies for example to the different images of the video sequence) or an audio content (in which case the notion of spatial resolution used in the following description is replaced by the notion of time resolution of the sound signal concerned).

FIG. 1 shows the main elements of an electronic device for encoding data representative of an original image IO having an initial spatial resolution.

This encoding device thus implements an encoding method, the steps of which will appear from the following description.

The initial spatial resolution is for example a resolution of more than 3000 pixels in the horizontal direction (i.e. an original image IO comprising more than 3000 columns of pixels) and/or a resolution of more than 1800 pixels in the vertical direction (i.e. an original image IO comprising more than 1800 rows of pixels), such as a resolution of 3840×2160 pixels (generally referred to as “4K format”).

In the example described herein, the original image IO is in the YUV format, i.e. the original image IO comprises a luminance component and two chrominance components. As an alternative, other formats with a luminance component and two chrominance components can be used, e.g. the YCrCb format. According to another alternative, mentioned in several places later on, the original image IO could be in the RGB format.

In these different examples, the original image comprises three components (defining together a colour image), each component having the above-mentioned initial spatial resolution.

The electronic encoding device 10 comprises a first colorimetric conversion unit 11, a subsampling unit 12, an encoding unit 14, a decoding unit 16, a second colorimetric conversion unit 17, an oversampling unit 18 and a learning unit 20.

Each of these units can be implemented in practice through execution, by a processor of the electronic encoding device 10, of dedicated computer program instructions to perform the functions described hereinafter for the unit concerned, when these instructions are executed by the processor.

However, as an alternative, one or more of these units could be implemented by a dedicated integrated circuit (different from the above-mentioned processor), e.g. an application-specific integrated circuit.

The first colorimetric conversion unit 11 is designed to convert the original image from a first colorimetric representation format (or system) (here, the YUV format) into a second colorimetric representation format (e.g. a display format), here the RGB format. Hereinafter, the so-obtained converted original image is denoted IR. The converted original image IR is therefore defined at the initial resolution.

The first colorimetric conversion unit 11 performs for example the colorimetric conversion by multiplying, for each pixel of the original image IO, a vector formed of the values of the different components of the original image IO for this pixel by a predefined conversion matrix, in order to obtain a vector comprising the values of the different components of this pixel in the converted original image IR. The number (here three) of components of the original image IO is here equal to the number of components in the converted original image IR. However, as an alternative, these numbers could be different from each other as, for example, in the case of a conversion from the RGB format to the CMYK (Cyan, Magenta, Yellow, Black) format, a format that is used in the technical field of printing.

In some embodiments (e.g. when the original image IO is already in the RGB format), the first colorimetric conversion unit 11 can be omitted.

The subsampling unit 12 is configured to subsample the original image IO into an image IDS with a lower spatial resolution than the initial spatial resolution.

This lower spatial resolution is for example a spatial resolution of less than 3000 pixels in the horizontal direction (i.e. the subsampled image IDS comprises less than 3000 columns of pixels) and/or a resolution of less than 1800 pixels in the vertical direction (i.e. a subsampled image IDS comprising less than 1800 rows of pixels), such as a resolution of 1920×1080 pixels or a resolution of 1280×720 pixels.

In the case where the initial spatial resolution is 3840×2160 pixels and the lower spatial resolution is 1920×1080 pixels, the initial spatial resolution is thus twice the lower spatial resolution in the horizontal dimension of the image and in the vertical dimension of the image.

The subsampling unit 12 performs the above-mentioned subsampling for example by Lanczos filtering, or, as an alternative, by phase extraction, or by bicubic filtering. According to still another alternative, the above-mentioned subsampling unit 12 can perform the above-mentioned subsampling using an artificial neural network.

Such a subsampling here applies separately to each component forming the original image IO.

The encoding unit 14 comprises a first encoding module 141 designed to encode the subsampled image IDS in order to obtain first data B1. This first encoding module 141 can be an intra image encoder of the HEVC or VVC type, or an encoder of the JPEG type. As an alternative, the first encoding module 141 can however perform another type of lossy encoding.

The decoding unit 16 is designed to perform an inverse decoding of the encoding performed by the first encoding module 141. Therefore, the decoding unit 16 produces, by decoding the first data B1, a decoded image IDSdec with the above-mentioned lower resolution. As the encoding used by the first encoding module 141 is a lossy encoding, the decoded image IDSdec is generally not strictly identical to the subsampled image IDS.

The second colorimetric conversion unit 17 is designed to convert the decoded image IDSdec from the first colorimetric representation format (or system) (here, the YUV format used for the original image IO, for the subsampled image IDS and thus for the decoded image IDSdec) into the second colorimetric representation format (e.g. a display format), here the RGB format. Hereinafter, the so-obtained converted decoded image is denoted A.

The second colorimetric conversion unit 17 performs for example the colorimetric conversion by multiplying, for each pixel of the decoded image IDSdec, a vector formed of the values of the different components of the decoded image IDSdec for this pixel by a predefined conversion matrix, in order to obtain a vector comprising the values of the different components of this pixel in the converted decoded image A. The number (here three) of components in the decoded image IDSdec is here equal to the number of components in the converted decoded image A. However, as an alternative, these numbers could be different from each other.

In some embodiments (as for example in the above-mentioned alternative, in which the original image IO is in the RGB format, or in the case of processing an audio signal), the second colorimetric conversion unit 17 can be omitted.

The oversampling unit 18 is configured to oversample the decoded image (here, after colorimetric conversion, i.e. the converted decoded image A) so as to obtain an intermediate image B at the initial spatial resolution.

The oversampling performed by the oversampling unit 18 is for example made using a filtering associated to the filtering used by the subsampling unit 12.

According to a first possible approach, the oversampling unit 18 can use a plurality of distinct filters each producing a phase (with the resolution of the decoded image, i.e. here the above-mentioned lower resolution) from the decoded image (here converted) A, and multiplex the different phases in order to obtain the intermediate image B.

For example, when the initial resolution is twice the lower resolution in the two dimensions of the image, the oversampling unit 18 uses 4 distinct filters producing respectively 4 phases from the (here converted) decoded image A and multiplex these 4 phases in order to obtain the intermediate image B.

According to a second possible approach, the oversampling unit 18 can insert rows and/or columns of zeros in the (here converted) decoded image A in order to obtain an image with the initial resolution, then apply to this image a convolution filter (for example, a bilinear filter or a bicubic filter or a Lanczos filter) in order to obtain the intermediate image B.

When the initial resolution is twice the lower resolution in the two dimensions of the image, the oversampling unit 18 inserts in this case a row of zero-value pixels below each row of pixels in the (here converted) decoded image A and a column of zero-value pixels after each column of pixels in the (here converted) decoded image, then applies the convolution filter to this image to obtain the intermediate image B.

Whichever approach is used, when the oversampling unit 18 makes the oversampling by means of a filter, it is possible in some embodiments to change the parameters of the filter during a learning phase that will be described hereinafter (which makes it possible, in particular, if necessary, to adapt the oversampling performed to the subsampling made by the subsampling unit 12).

The learning unit 20 comprises a filtering module 22 and an optimisation module 24.

The filtering module 22 receives as an input the intermediate image B and is designed to apply to this intermediate image B a convolution by means of a convolution matrix or, in some embodiments, as those shown hereinafter, a plurality of convolutions, each made by means of a convolution matrix.

The filtering module thus produces an image C (having the same spatial resolution as the intermediate image B, i.e. the initial spatial resolution).

In some embodiments, the filtering module 22 can implement an artificial neural network, wherein each of the above-mentioned convolutions can then be performed using a layer of the artificial neural network.

The coefficients of the convolution matrix defining a given convolution performed by the filtering module 22 are then respectively the weights associated with the neurons of the layer corresponding to this given convolution in the artificial neural network.

Each convolution matrix (also called “convolution kernel”) has a number of elements (or coefficients) far lower than the number of pixels in the intermediate image B, for example a number of elements less than one ten-thousandth of the number of pixels in the intermediate image B (i.e. in the initial resolution).

The number of elements in each convolution matrix can in practice be less than 256.

In the examples described hereinafter with reference to FIGS. 3 to 7, the convolution matrices are matrices including a maximum of 5 rows and 5 columns (matrices 5×5) and thus comprise 25 elements (or coefficients).

Therefore, the filtering module 22 applies the convolution (or the series of convolutions) successively to blocks of pixels extracted from the intermediate image B (here, for each of the three components of the intermediate image B), these blocks having the same dimensions as the one or more convolution matrices, so as to produce, for each extracted block of pixels, a value of a pixel (of a component) of the image C.

In the embodiments using a neural network (as already mentioned), each layer of the artificial neural network applies a given convolution to all the pixel values received at the input of the layer concerned (by applying the convolution matrix successively to the different blocks of pixels received at the input, these blocks of pixel being of same size as the convolution matrix) so as to produce, at the output of the layer concerned, a set of pixel values (or latent values) of same size as the intermediate image C or, for the last layer, all the values of the pixels of the image C.

As is usual in an artificial neural network, the pixel values (or latent values) produced by a given layer are applied to the input of the following layer.

Each layer of the artificial neural network can apply, in addition to the above-mentioned convolution, at least another function, such as a linear function (or activation function), for example a function of the ReLu (or rectifier) type. In this case, the activation function is for example applied to each pixel value produced by the convolution associated with the layer concerned and each value produced by the activation function forms a pixel value (latent value) to be applied to the input of the following layer.

The coefficients of the convolution matrices, i.e. in this case the weights defining the artificial neural network, are determined during a learning phase described hereinafter.

The optimisation module 24 receives as an input the image C produced at the output of the filtering module 22 and the converted original image IR produced by the first colorimetric conversion unit 11 and determines a distance between these two images, for example a measurement of distortion between these two images.

The optimisation module 24 is configured to test, for at least one convolution (i.e. for at least one layer of the artificial neural network), a plurality of predefined locations of the coefficients within the convolution matrix concerned, and, each time, to determine the coefficients (i.e. the weights of the layer concerned in the artificial neural network) which minimise the above-mentioned distance between the image C and the image IR, or, as an alternative, a rate-distortion cost involving not only a measurement of distortion between the image C and the image IR but also a measurement of the amount of information required for encoding the image IO.

As already indicated, the parameters optimised so as to minimise the above-mentioned distance (or the above-mentioned rate-distortion cost) can include, in addition to the coefficients (or weights) of the one or more convolution matrices, the parameters of the filter used by the oversampling unit 18.

In the example described herein, each predefined location of the coefficients (or weights) within the convolution matrix is defined by the shape and the extent of a pattern at which the coefficients (or weights) are placed within the convolution matrix concerned (the coefficients of this convolution matrix outside this pattern being systematically zero).

In this context, the optimisation module 24 may possibly further test some coefficient locations each defined by superimposing several patterns, each defined by a shape and an extent, as explained hereinafter with reference in particular to FIG. 7.

The above-mentioned location of the coefficients among a plurality of predefined locations can be tested separately for several convolutions used (i.e. for several layers of the artificial neural network), wherein the number of these convolutions can be variable.

For example, a set of possible configurations is defined as follows:
a first group of configurations defined by considering all the locations contemplated for the first convolution contemplated (i.e. for the first layer of the artificial neural network), the subsequent convolutions (i.e. the subsequent layers of the artificial neural network) being predetermined, i.e. performed by means of predetermined convolution matrices;
a second group of configurations defined by considering all the locations contemplated for the first convolution contemplated (i.e. for the first layer of the artificial neural network) and all the locations contemplated for the second convolution contemplated (i.e. for the second layer of the artificial neural network) according to all the possible combinations, the subsequent convolutions (i.e. the subsequent layers of the artificial neural network) being predetermined, i.e. performed by means of predetermined convolution matrices;
a third group of configurations defined by considering all the locations contemplated for the first convolution contemplated (i.e. for the first layer of the artificial neural network), all the locations contemplated for the second convolution contemplated (i.e. for the second layer of the artificial neural network) and all the locations contemplated for the third convolution contemplated (i.e. for the third layer of the artificial neural network) according to all the possible combinations, the subsequent convolutions (i.e. the subsequent layers of the artificial neural network) being predetermined, i.e. performed by means of predetermined convolution matrices;
and so on until obtaining a group of configurations in which all the contemplated locations are considered for all the convolutions (i.e. for all the layers of the artificial neural network) in all the possible combinations, without predetermined convolution.

According to a possible alternative, the number of convolutions (i.e. the number of layers of the artificial neural network) for which the location of the coefficients is variable among several possible locations is predetermined, which makes it possible to reduce the number of configurations to be tested.

During a learning phase, for each of the possible configurations defined hereinabove, the optimisation module 22 determines (e.g. using a least squares method or gradient descent) the coefficients (or weights) of the one or more convolution matrices, located at the places specified by the configuration concerned, and possibly the parameters of the filter of the oversampling unit 18, which minimise the criterion used (e.g., as already indicated, the measurement of distortion between the image IR and the image C, or, as an alternative, a rate-distortion cost) and stores, in association with the current configuration, the so-obtained minimum value of the criterion used for this configuration.

When all the configurations have been tested, the optimisation module 22 selects the configuration for which the stored value of the criterion used is optimum (here minimum); it is for example the configuration for which the distortion measurement stored is minimum.

According to a possible alternative, instead of using predetermined convolutions for the last layers, as proposed hereinafter, it is possible to use convolutions whose coefficient location is predetermined (e.g. extended over the whole convolution matrix), but the coefficient value of which is determined during the learning phase.

The optimisation module 22 thus produces, for at least one convolution (i.e. a layer of the artificial neural network) for which several coefficient locations have been tested, a set of coefficients (or weights) and a location of these latter (corresponding to the selected configuration) which belongs to the plurality of locations tested.

Especially, in the example described here, the optimisation module 22 outputs:
the number NNL of convolutions (i.e. of layers of artificial neural networks) defined by a pattern and weights (as explained hereinafter) in the selected configuration, the subsequent convolutions being predetermined;
for each of these NNL convolutions (i.e. for each of the NNL first layers of the artificial neural network), the location of the weights (or coefficients) within the convolution matrix among the plurality of locations tested and the weights (or coefficients) W to be used at the places defined (within the convolution matrix) by this location.

In the above-mentioned alternative, in which only the location relating to the subsequent convolutions is predetermined (but not the value of the weights or coefficients defining these subsequent convolutions), the optimisation module 22 also outputs the weights to be used (at the predetermined places) for the subsequent convolutions.

In some embodiments, the optimisation module 24 can also output the optimised parameters of the filter used by the oversampling unit 18.

The encoding unit 14 comprises a second encoding module 142 designed to encode (for each convolution for which such weights are determined by the learning process described hereinabove, i.e. here for NNL convolutions) the weights W so as to obtain second data B2.

The second encoding module 142 can perform a lossy encoding or a lossless encoding.

According to a first possible embodiment, the second encoding module 142 quantizes the weights W with a determined quantization step, then applies a known entropic encoding algorithm, such as the arithmetic encoding or the Huffman encoding.

According to a second possible embodiment, the second encoding module 142 encodes the weights W (that define as indicated hereinabove layers of an artificial neural network) in accordance with standard MPEG-7 part 17 (used to encode the parameters of an artificial neural network).

The encoding unit 14 also comprises a third encoding module 143 designed to encode (for each convolution for which weights are defined, i.e. here for NNL convolutions) the location L of the weights W within the convolution matrix concerned so as to form third data B3. The volume of the third data B3 being relatively small, the third encoding module 143 here uses a lossless encoding technique, for example by juxtaposing the data indicated hereinafter (number NNL, flag or identifier(s) and/or parameter(s) for each of the NNL convolutions).

In the example described herein, the third data B3 define at least one pattern at which the weights W are placed within the convolution matrix concerned.

For that purpose, these third data B3 comprise:
fourth data defining the shape of the above-mentioned pattern, and that can for example comprise an identifier that identifies this shape among a plurality of predetermined shapes;
optionally, data defining an extent of this pattern.

According to a possible embodiment, the third data B3 comprise:
the number NNL of convolutions (i.e. here the number of layers of the artificial neural network) for which are available location information L such as the following;
for each of these NNL convolutions (i.e. here for each of these NNL layers of the artificial neural network), a use_default_loc flag indicating if a default convolution pattern (e.g. a 3×3 convolution matrix) is used (case where use_default_loc is equal to 1);
a loc_type identifier (belonging to above-mentioned fourth data) identifying a pattern shape among a plurality of predetermined shapes and/or a loc_scale parameter defining the extent of the pattern when, for a convolution (i.e. for a layer of the artificial neural network), the use_default_loc flag is equal to 0 (the pattern defined by the loc_type identifier and the loc_scale parameter then indicating, as already mentioned, the positions of the weights W encoded by some of the second data B2 within the convolution matrix concerned).

As indicated hereinabove, the NNL layers of the artificial neural network that are concerned are here the NNL first layers of this artificial neural network, wherein the location information can be encoded from the first layer to the layer of order NNL.

In the above-mentioned alternative in which the number of convolutions (i.e. here the number of layers of the artificial neural network) for which the coefficient location is variable is predetermined (the subsequent layers using a predefined location of the coefficients in each convolution matrix concerned), the number NNL can be omitted from the third data B3.

Some examples of usable predetermined pattern shapes will be described hereinafter with reference to FIGS. 4 and 6.

The encoding unit 14 can also be configured to encode the optimised parameters of the filter used by the oversampling unit 18.

The encoded data B1, B2, B3 can be stored within the encoding device 10 for future use, or transmitted to a decoding device (e.g. as that described hereinafter with reference to FIG. 2) using a communication unit (not shown) of the encoding device 10.

When the encoded data B1, B2, B3 (representative of the original image IO) are transmitted that way, the transmitted data stream then comprises:
the first data B1 representing the image at the lower resolution (image IDS);
the second data B2 representing the weights W usable as coefficients of a convolution matrix useful (as explained hereinafter) for filtering an image at the initial resolution obtained by oversampling of the image IDS at the lower resolution;
the third data B3 indicating a location of these weights within the convolution matrix.

This data stream can possibly further comprise the optimised parameters of a filter usable for the above-mentioned oversampling (which corresponds to the filter used by the oversampling unit 18).

In the case already mentioned in which the audio or visual content is a video sequence, it can be provided that the learning process described above applies for each image of the video sequence, which thus makes it possible to obtain location information L and weights W (as well as, possibly, optimized parameters of an oversampling filter) for each of the images of the video sequence.

In this case, the data stream representative of the video sequence comprises, for each image of the video sequence:
first data representing the image concerned at the lower resolution;
second data representing weights usable as coefficients of a convolution matrix useful for filtering an image at the initial resolution obtained by oversampling of the image concerned at the lower resolution;
third data indicating a location of these weights within the convolution matrix;
possibly, optimised parameters of a filter usable for this oversampling.

FIG. 2 shows the main elements of an electronic device 30 for decoding such data representing an image.

This decoding device thus implements a decoding method, the steps of which appear from the following description.

The electronic decoding device 30 comprises a decoding unit 32, a colorimetric conversion unit 34, an oversampling unit 36 and a filtering unit 38.

Each of these units can be implemented in practice through execution, by a processor of the electronic decoding device 30, of dedicated computer program instructions to perform the functions described hereinafter for the unit concerned, when these instructions are executed by the processor.

However, as an alternative, one or more of these units could be implemented by a dedicated integrated circuit (different from the above-mentioned processor), e.g. an application-specific integrated circuit.

The data B1, B2, B3 processed by the electronic decoding device 30, as explained hereinafter, are for example received by a receiving unit (not shown) of the electronic decoding device 30.

As an alternative, the electronic encoding device 10 described with reference to FIG. 1 and the electronic decoding device 30 can have access to a same memory (not shown), in particular when the encoding device 10 and decoding device 30 are the same electronic device, and the data B1, B2, B3 (stored in this memory of the encoding device 10 as described hereinabove) can be read in this memory.

The decoding unit 32 comprises a first decoding module 321 designed to decode the first data B1 so as to obtain a decoded image IDSdec at a first resolution (here, the above-mentioned lower resolution).

The first decoding module 321 is of the same type as the decoding unit 16 used by the encoding device 10 and reference can therefore be made to the explanations given above concerning the decoding unit 16.

The decoding unit 32 comprises a second decoding module 322 designed to decode the second data B2 so as to obtain a plurality of weights Wo. The so-obtained decoded weights are here denoted Wo; indeed, as the encoding technique used to encode the second data B2 can be a lossy encoding technique, the decoded weights Wo may not be strictly identical to the weights W obtained in the encoding process described hereinabove with reference to FIG. 1.

The decoding unit 32 comprises a third decoding module 323 designed to decode the third data B3 indicating, for each convolution matrix for which weights are encoded by the second data B2, a location L of these weights within the convolution matrix concerned.

As mentioned hereinabove, these third data B3 here comprise:
a number NNL of convolutions (i.e., as explained hereinafter, of layers of an artificial neural network) for which weights are encoded among the second data B2;
for each of these NNL convolutions, a use_default_loc flag indicating if a default convolution pattern is used (within a convolution matrix) for the convolution concerned;
for each convolution for which the default convolution pattern is not used, a loc_type identifier (fourth data) identifying a convolution pattern shape (within the convolution matrix concerned) among a plurality of predetermined shapes and/or a loc_scale parameter defining the extent of the convolution pattern.

For each convolution for which weights are encoded among the second data B2, the third data B3 thus define a patter representing, within the convolution matrix concerned, the places at which the decoded weights will be used as coefficients of the convolution matrix (the other coefficients of the convolution matrix being zero).

The colorimetric conversion unit 34 is designed to convert the decoded image IDSdec from a first colorimetric representation format (here, the YUV format used for the original image IO and for the decoded image IDSdec) into a second colorimetric representation format (e.g. a display format), here the RGB format. This colorimetric conversion unit 34 is here of the same type as the second colorimetric conversion unit 17.

The colorimetric conversion unit 34 performs for example the colorimetric conversion by multiplying, for each pixel of the decoded image IDSdec, a vector formed of the values of the different components of the decoded image IDSdec for this pixel by a predefined conversion matrix, in order to obtain a vector comprising the values of the different components of this pixel in the converted decoded image. The number (here three) of components in the decoded image IDSdec is here equal to the number of components in the converted decoded image. However, as an alternative, these numbers could be different from each other.

In some embodiments (as for example when the decoded image IDSdec is in the RGB format, or in the case of processing of an audio signal), the colorimetric conversion unit 34 can be omitted.

The oversampling unit 36 is configured to oversample the decoded image IDSdec (here converted by the colorimetric conversion unit 34), which is at the first resolution, into an image IUS at a second resolution higher than the first resolution (this second resolution is here the initial resolution, i.e. the resolution of the original image IO).

The oversampling performed by the oversampling unit 36 is for example made using a filtering associated with the filtering used by the subsampling unit 12. In the embodiments in which optimised parameters relating to the oversampling are transmitted as indicated hereinabove, this filtering can be defined by theses parameters. In the other cases, the oversampling unit 36 uses for example a predefined filtering.

According to a first possible approach, the oversampling unit 36 can use a plurality of distinct filters each producing a phase (having the resolution of the decoded image IDSdec, i.e. here the first resolution) from the decoded image IDSdec (here converted by the colorimetric conversion unit 34), and multiplex the different phases in order to obtain the image IUS at the second resolution.

For example, when the second resolution is twice the first resolution in the two dimensions of the image, the oversampling unit 36 uses 4 distinct filters producing respectively 4 phases from the decoded image IDSdec (here converted by the colorimetric conversion unit 34) and multiplex these 4 phases in order to obtain the image IUS at the second resolution.

According to a second possible approach, the oversampling unit 36 can insert rows and/or columns of zeros in the decoded image IDSdec (here converted by the colorimetric conversion unit 34), then apply to this image a convolution filter (for example, a bilinear filter or a bicubic filter or a Lanczos filter) in order to obtain the image IUS at the second resolution.

When the second resolution is twice the first resolution in the two dimensions of the image, the oversampling unit 36 inserts a row of zero-value pixels below each row of pixels of the decoded image IDSdec (here converted by the colorimetric conversion unit 34) and a column of zero-value pixels after each column of pixels in the decoded image IDSdec (here converted by the colorimetric conversion unit 34), then applies a convolution filter to this image.

The filtering unit 38 is configured to apply a filtering to the image IUS at the second resolution in order to obtain a final image IF, this filtering comprising a convolution or several successive convolutions by means, respectively, of one or several convolution matrices defined by the second data B2 and the third data B3.

In the example described herein, the filtering unit 38 implements an artificial neural network whose successive layers implement respectively the convolutions used to perform the filtering applied by the filtering unit 38 as mentioned hereinabove.

The filtering unit 38 is of the same type as the filtering module 22 described hereinabove. However, the coefficients of the convolution matrices used in the filtering unit 38 are determined as a function of the encoded data B2, B3 received by the decoding device (whereas the coefficients of the convolution matrices used in the filtering module 22 vary during the learning phase described hereinabove).

The filtering unit 38 uses the weights Wo (obtained from the encoded data B2) and the location information L of the weights (obtained from the encoded data B3) to configure the different convolutions used (i.e. to define, for some at least of the convolutions used, the associated convolution matrix, in other words here the weights of the layer of the artificial neural network implementing this convolution): for each convolution defined by some of the data B2, B3, the filtering unit 38 determines, based on the location information L relating to this convolution, places within the convolution matrix defining this convolution, and set the coefficients of the convolution matrix located at these places (taken in a predefined order) to the respective values of the weights Wo relating to this convolution (or, in other words, uses, as coefficients of the convolution matrix located at these places, respectively and in a predefined order, the weights Wo relating to this convolution).

In the example described herein, the filtering unit 38 performs for that purpose the following steps:
for each of the NNL first convolutions (i.e. here for each of the first layers of the artificial neural network), reading the use_default_loc flag indicating if a default convolution pattern is used (within a convolution matrix) for the convolution concerned;
if the use_default_loc flag indicates that a default convolution pattern is used, configuring the convolution matrix concerned (i.e. here the artificial neural network layer concerned) using, for the coefficients located at the places of the default convolution pattern, respectively the weights Wo obtained from the data B1 for this convolution (the coefficients located outside the places of the default convolution pattern being set to zero);
if the use_default_loc flag indicates that the default convolution pattern is not used, determining the target places (within the convolution matrix concerned) based on the convolution pattern shape identified by the loc_type identifier and on the extent of this pattern defined by the loc_scale parameter, and configuring the convolution matrix concerned (i.e. here the artificial neural network layer concerned) using, for the coefficients located at the target places, respectively the weights Wo obtained from the data B1 for this convolution (the coefficients located outside the target places being set to zero);
for each of the potential convolutions (or artificial neural network layers) posterior to the NNL first convolutions (layers), using a predetermined convolution matrix (wherein distinct predetermined convolution matrices can possibly be used for these different posterior convolutions), i.e. configuring the artificial neural network layer concerned using this predetermined convolution matrix.

To determine the target places based on the pattern shape and the pattern extent, the filtering unit 38 applies for example a homothety to the places defined by the pattern shape, such homothety being centered to the center of the convolution matrix (or kernel) and having ratio equal to the pattern extent.

Moreover, in some embodiments, several pairs of loc_type identifier and loc_scale parameter can be associated with a same convolution: a place is then a target place if it is present in at least one of the patterns defined by one of the loc-type identifier-loc_scale parameter pair associated with this convolution.

FIGS. 4 to 7 give examples of target place definition in a convolution matrix based on at least one loc-type identifier-loc_scale parameter pair.

Thanks to the processing of the image IUS at the second resolution by a filtering (performed by the filtering unit 38) adapted to this image (the coefficients, or weights, of the convolution matrices and their places as encoded in the data B2, B4 being specifically associated with this image), the final image IF is closer to the original image IO than the image IUS.

The image IF can then, for example, be displayed on a display device (e.g. at the second resolution).

FIGS. 3 to 7 show examples of convolution matrix (or kernel) than can be used within the filtering module 22 and the filtering unit 38.

In all these examples, hereinafter, x(i,j) will be used to refer to the value of a pixel at row i and column j in the image (or more generally in the set of values) to which the convolution defined by this convolution matrix is applied, and y(i,j) will be used to refer to the value of the pixel at row i and column j in the image (or more generally in the set of values) obtained by application of the convolution.

FIG. 3 shows a first example of convolution matrix.

In the example described herein, the location of the coefficients in this convolution matrix of FIG. 3 is defined by the default pattern; it is hence the convolution matrix used when the use_default_loc flag is equal to 1 for a given convolution.

The processing performed by this convolution is written:

$$y ( i , j ) = a 1 . x ( i - 1 , j - 1 ) + a 2 . x ( i - 1 , j ) + a 3 . x ( i - 1 , j + 1 ) + a 4 . x ( i , j - 1 ) + a 5 . x ( i , j ) + a 6 . x ( i , j + 1 ) + a 7 . x ( i + 1 , j - 1 ) + a 8 . x ( i + 1 , j ) + a 9 . x ( i + 1 , j + 1 ) .$$

By way of example, two predefined pattern shapes are used hereinafter:
an X pattern, the shape of which is defined here by an identifier ID1;
a cross pattern, the shape of which is defined here by an identifier ID2.

Other predefined pattern shapes can of course be used in practice.

For the convolution matrix examples given in the following with reference to FIGS. 4 to 7, the use_default_loc flag is equal to 0 in the described example (because, in these examples, the weights used are not positioned in the convolution matrix according to the default pattern used for FIG. 3).

FIG. 4 shows a second example of convolution matrix.

In the example described herein, the location of the coefficients in this convolution matrix is defined by the identifier ID1 (here associated with the X pattern shape) and by an extent parameter equal to 1 (meaning that the pattern defined by the identifier ID1 is used as such or, in other words, by application of a homothety of ratio 1).

The processing performed by this convolution is written:

$$y ( i , j ) = a 1 . x ( i - 1 , j - 1 ) + a 2 . x ( i - 1 , j + 1 ) + a 3 . x ( i , j ) + a 4 . x ( i + 1 , j - 1 ) + a 5 . x ( i + 1 , j + 1 ) .$$

FIG. 5 shows a third example of convolution matrix.

In the example described herein, the location of the coefficients in this convolution matrix is defined by the identifier ID1 (here associated with the X pattern shape) and by an extent parameter equal to 2 (meaning that the pattern defined by the identifier ID1 is used transformed by application of a homothety centred on the central coefficient, here a3, and of ratio 2).

The processing performed by this convolution is written:

$$y ( i , j ) = a 1 . x ( i - 2 , j - 2 ) + a 2 . x ( i - 2 , j + 2 ) + a 3 . x ( i , j ) + a 4 . x ( i + 2 , j - 2 ) + a 5 . x ( i + 2 , j + 2 ) .$$

FIG. 6 shows a fourth example of convolution matrix.

In the example described herein, the location of the coefficients in this convolution matrix is defined by the identifier ID2 (here associated with the cross pattern shape) and by an extent parameter equal to 1 (meaning that the pattern defined by the identifier ID2 is used as such or, in other words, by application of a homothety of ratio 1).

The processing performed by this convolution is written:

$$y ( i , j ) = a 1 . x ( i - 1 , j ) + a 2 . x ( i , j - 1 ) + a 3 . x ( i , j ) + a 4 . x ( i , j + 1 ) + a 5 . x ( i + 1 , j ) .$$

FIG. 7 shows a fifth example of convolution matrix.

In the example described herein, the location of the coefficients in this convolution matrix is defined by two identifier-parameter pairs (and thus by superimposition of a first pattern and a second pattern):
the identifier ID1 (here associated with the X pattern shape) and an extent parameter equal to 1, meaning that the first pattern is the pattern defined by the identifier ID1 used as such;
the identifier ID1 (here associated with the X pattern shape) and an extent parameter equal to 2, meaning that the second pattern defined is the pattern defined by the identifier ID1 transformed by application of a homothety centred on the central coefficient, here a5, and of ratio 2.

The processing performed by this convolution is written:

$$y ( i , j ) = a 1 . x ( i - 2 , j - 2 ) + a 2 . x ( i - 2 , j + 2 ) + a 3 . x ( i - 1 , j - 1 ) + a 4 . x ( i - 1 , j + 1 ) + a 5 . x ( i , j ) + a 6 . x ( i + 1 , j - 1 ) + a 7 . x ( i + 1 , j + 1 ) + a 8 . x ( i + 2 , j - 2 ) + a 9 . x ( i + 2 , j + 2 ) .$$

As can be seen from the examples given above, only the location of the coefficients is defined by the location information (encoded by the data B3). The values of the coefficients (denoted ak hereinabove, with k between 1 and 9) are given by the weights W, Wo (encoded by the data B2).

As already indicated, the weights Wo (denoted a1, a2, etc., hereinabove) are allocated to the coefficients defined by the location information L according to a predefined order, for example by increasing row index (denoted i hereinabove), and in each row, by increasing column index (denoted j hereinabove), as it is the case in the examples of FIGS. 3 to 7.

1. A method for decoding data representative of an audio or visual content, the method comprising:
decoding first data to obtain a first signal at a first resolution;
decoding second data to obtain a plurality of weights;
oversampling the first signal at the first resolution into a second signal at a second resolution higher than the first resolution;
filtering the second signal at the second resolution, the filtering comprising at least one convolution by at least one convolution matrix, at least some coefficients of which are respectively weights of the plurality of weights.

2. The method according to claim 1, further comprising decoding third data indicating a location of said weights within the at least one convolution matrix.

3. The method according to claim 2, wherein the third data comprise fourth data defining a shape of a pattern at which said weights are placed within the at least one convolution matrix.

4. The method according to claim 3, wherein the fourth data comprise an identifier that identifies said shape among a plurality of predetermined shapes.

5. The method according to claim 3, wherein some at least of the third data define an extent of said pattern within the at least one convolution matrix.

6. The method according to claim 1, wherein the at least one convolution comprises a plurality of convolutions,
at least one convolution matrix comprises a plurality of convolution matrices, and
wherein said filtering comprises implementing the plurality of convolutions respectively by the plurality of convolution matrices each defined at least in part by the weights obtained by decoding part of the second data.

7. The method according to claim 2, wherein the at least one convolution comprises a plurality of convolutions,
at least one convolution matrix comprises a plurality of convolution matrices,
wherein said filtering comprises implementing the plurality of convolutions respectively by the plurality of convolution matrices each defined at least in part by the weights obtained by decoding part of the second data, and
wherein the third data comprise, for each convolution matrix of the plurality of convolution matrices, location data indicating a location of the weights within the respective convolution matrix.

8. The method according to claim 2,
wherein the at least one convolution comprises a plurality of convolutions,
at least one convolution matrix comprises a plurality of convolution matrices,
wherein said filtering comprises implementing the plurality of convolutions respectively by the plurality of convolution matrices each defined at least in part by the weights obtained by decoding part of the second data, and
wherein the third data comprise a number of the convolutions for which the third indicate the location of the weights.

9. The method according to claim 2, wherein the at least one convolution comprises a plurality of convolutions,
at least one convolution matrix comprises a plurality of convolution matrices,
wherein said filtering comprises implementing the plurality of convolutions respectively by the plurality of convolution matrices each defined at least in part by the weights obtained by decoding part of the second data, and
wherein the number of the convolutions for which the third data indicate the location of the weights is determined.

10. The method according to claim 8, wherein the convolutions for which the third data indicate the location of the weights are the first convolutions.

11. The method according to claim 1, wherein the at least one convolution matrix is a predetermined convolution matrix.

12. The method according to claim 1, wherein said at least one convolution is implemented by a layer of an artificial neural network.

13. The method according to claim 12, further comprising decoding some data indicating a number of layers of the artificial neural network for which weights are encoded among the second data.

14. The method according to claim 1, wherein the second resolution is twice the first resolution in each one of the dimensions of the signal.

15. The method according to claim 1, wherein the audio or visual content is an image, and
wherein the first resolution and second resolution are spatial resolutions.

16. The method according to claim 15, wherein the image is defined by a plurality of components, and
wherein the decoding the first data is followed by converting from a first color representation system to a second color representation system.

17. A method for encoding data representative of an audio or visual content, the method comprising the following steps:
subsampling, into a first signal at a first resolution, a second signal at a second resolution higher than the first resolution;
encoding the first signal at the first resolution to obtain first data;
obtaining an intermediate signal by decoding the first data and oversampling to the second resolution;
determining a plurality of weights that minimize a criterion involving a distance between the second signal at the second resolution, transformed by colorimetric conversion or not, and a filtered signal produced by filtering the intermediate signal using at least one convolution by a convolution matrix, at least some coefficients of which are respectively weights of the plurality of weights; and
encoding the determined weights to obtain second data.

18. The encoding method according to claim 17, further comprising, for each of a plurality of configurations of the weights within the convolution matrix, determining a set of the weights that minimizes a criterion involving a distance between the second signal at the second resolution and the filtered signal produced by filtering the intermediate signal using the at least one convolution by the convolution matrix having a respective configuration defined by the set of weights, the encoded weights being the weights of the set of weights for which the produced filtered signal satisfies a predetermined criterion.

19. The encoding method according to claim 18, further comprising encoding third data indicating the location of the weights within the convolution matrix in the configuration for which the produced filtered signal satisfies the predetermined criterion.

20. A device for decoding data representative of an audio or visual content, the device comprising:
one or more processors configured to;
decode first data to obtain a first signal at a first resolution and second data to obtain a plurality of weights;
oversample the first signal at the first resolution into a second signal at a second resolution higher than the first resolution, and
filter the second signal at the second resolution, the one or more processors being configured to apply at least one convolution by a convolution matrix, at least some of the coefficients of which are respectively weights of the plurality of weights.

21. A device for encoding data representative of an audio or visual content, the device comprising:
one or more processors configured to:
subsample, into a first signal at a first resolution, a second signal at a second resolution higher than the first resolution,
encode the first signal at the first resolution to obtain first data,
obtain a decoded signal at the first resolution by decoding the first data,
oversample the decoded signal, respectively transformed by colorimetric conversion or not, to obtain an intermediate signal at the second resolution,
determine a plurality of weights that minimize a criterion involving a distance between the second signal at the second resolution, respectively transformed by colorimetric conversion or not, and a filtered signal produced by filtering the intermediate signal using at least one convolution by a convolution matrix, at least some coefficients of which are respectively weights of the plurality of weights,
wherein the one or more processors is configured to encode the determined weights to obtain second data.

22. (canceled)

23. (canceled)
